(19) United States
(12) Patent Application Publication
(10) Pub. No.: US 2022/0170205 A1
(43) Pub. Date: Jun. 2, 2022

(54) Crossover Rope Splice for Creation of Eye

(71) Applicant: Richardson Capex, LLC, Beaumont, TX (US)

(72) Inventor: Christopher L. Richardson, Beaumont, TX (US)

(21) Appl. No.: 17/430,643

(22) PCT Filed: Feb. 26, 2019
(86) PCT No.: PCT/US19/19589

§ 371 Date: Aug. 12, 2021

(51) Int. Cl. D07B 1/18; B66C 1/12

(52) U.S. Cl. CPC D07B 1/185; B66C 1/12

(57) ABSTRACT

Disclosed invention is a method to create slings in a rope and the product of the method. The splice in the present invention creates the splice primarily in the eye of the sling as opposed to the body of the sling. By creating the splice in the eye, the amount of rope needed for the splice is reduce, allowing for greater flexibility in the length of the resulting sling, and lower overall weight.

### FIELD OF THE INVENTION

The present invention involves the creation of an eye for a sling or other rope assembly with minimal extra materials needed, reducing the weight and reducing the minimum sling length.

### BACKGROUND OF THE INVENTION

Various loading operations typically make use rope assemblies with an eye in at least one end of the rope. The eye is a formation in the rope where the rope loops back onto itself, forming an aperture where operators connect loads. While such an eye may be formed using a knot, the more common method involves splicing of rope, where fibers are unwoven and rewoven back together to fasten sections of a rope together. While a sling in this case may be a rope with a single eye, there may be multiple eyes in the rope. Further, such slings may be used as mooring lines or winch lines in shipping or other embodiments.

Splicing typically occurs in the main body of the rope, leaving the eye to be formed from an unaltered length of the rope. Currently the standard splice is either a “tuck and bury” splice or a full splice using each strand of the multi strand rope, which is known to those skilled in the art. A significant length is rope is used to form the eye using these methods. Using these methods, a rope is looped back onto itself to form the eye, and the distal end of the rope is woven back into the central body of the rope starting at the base of the throat, making the throat in the rope and part of the central section of the rope with the tuck and bury or spliced section appreciably thicker than it was before the splice. The amount of rope used in this method to create a spliced eye is twice the length of the eye and up to forty two times the rope diameter. As a consequence, a significant amount of rope is used to create the eye, increasing the weight of the rope overall and the thickness in the throat.

The tuck and bury splice or full splice also puts limitations on the slings based on the proportions of minimal sling length compared to eye size. Larger eyes require larger splices. The need for length of the splice thus increases the length of the sling due to the minimum requirement of a distance of ten times the body diameter of rope between the base of each splice. The means that larger and stronger ropes require that much more rope to complete a splice. As a result, there is a point where a sling may either be made from rope that is strong enough to hold the load, but might be too long to be useful. Alternatively, the sling might be the correct length, but the rope is too weak to accomplish the job. Therefore, a need exists to form an eye for a sling that allows greater versatility in strength and rope required.

### BRIEF SUMMARY OF INVENTION

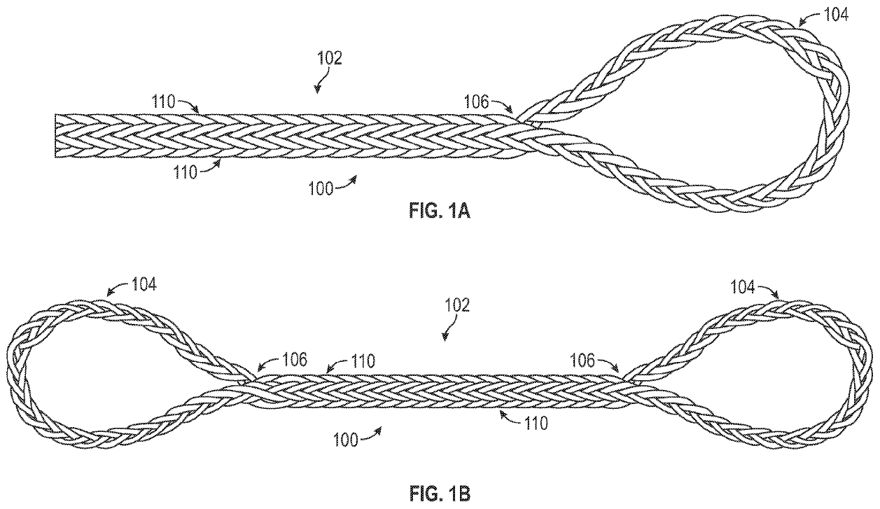

An exemplary embodiment of the invention is a sling 102 with at least one eye 104 created by rope 100 with strands 110 reoriented and rethreaded in opposite directions terminating in the throat 106 of the sling 102. The sling 102 is made of a multi strand rope 100 where the strands 110 separate at the throat 106, and then go in opposing direction through the eye 104, coming back to the throat 106, where they then tucked back into the rope 100, securing the eye 104. FIG. 1a shows the sling 102 with a single eye 104, while FIG. 1b shows a sling 102 with two eyes 104.

An additional exemplary embodiment of the invention is the method by which the sling 102 with at least one eye 104 is produced. The method involves forming the eye 104 with the rope 100, then withdrawing a strand 110 up to the central throat section and reintroducing the strand 110 back into the through the distal throat section 204. Introducing the strand 110 through the distal throat section 204 may include introducing the strand 110 back through distal end of the rope 100 or the distal throat section 204. The effect of the rethreading is having the strand 110 occupy substantially the same location as it did before, but going in an opposite direction. This process is repeated, resulting in multiple strands 110 being rethreaded in this manner, creating a splice in the eye 104 itself.

In one exemplary embodiment of the process, a first primary oriented strand 220 is pulled out from the rope 100 where the primary oriented strand distal end 222 is loosened all the way up to the central throat section 214. The first primary oriented strand 220 is pulled out braid by braid until the appropriate amount of the first primary oriented strand 220 is released in the central throat section 214. The removal of the first primary oriented strand 220 creates a void in the rope 100. The first primary oriented strand 220 is rethreaded into the rope 100 by being rethreaded back into the void created by the removal of the first primary oriented strand 220 from the rope 100. The first primary oriented strand distal end 222 is inserted back into the rope 100 starting at the distal throat section 204 of the rope 100 where it is rebraided. Eventually the first primary oriented strand distal end 222 exits at the central throat section 214. The primary oriented strand distal end 222 is then coupled to the rope 100. A common method for coupling is known as tucking.

With the first primary oriented strand 220 fixed, the process is repeated with a first alternative oriented strand 230. A first alternative oriented strand 230 is pulled out from the rope 100 where the alternative oriented strand distal end 232 is loosened all the way up to the central throat section 214. In an exemplary embodiment, the first single alternative oriented strand 230 is pulled out braid by braid until the appropriate amount of the first alternative oriented strand 230 is released. The removal of the first single alternative oriented strand 230 creates a void in the rope 100. The first single alternative oriented strand 230 is rethreaded into the void created by the removal of the first single alternative oriented strand 230 from the rope 100. The first single alternative oriented strand distal end 232 is inserted back into the rope 100 starting at the distal throat section 204 where it is rebraided. Eventually the first alternative oriented strand distal end 232 exits at the central throat section 214. The alternative oriented strand distal end 232 is then coupled to the rope 100.

The process with the primary oriented strands 220 and alternative oriented strands 230 is repeated until a sufficient number of strands 110 have been rewoven to form an eye 104. While the exemplary embodiments have the primary oriented strands 220 and alternative oriented strands 230 filling the void they previously occupied, the strands may be threaded back through the eye 104 in any way known to those skilled in the art without departing form the scope of the invention.

In an exemplary embodiment, the sling 102 of braided rope 100, comprises a main rope 100 body comprising a plurality of strands woven together in a first direction; an eye 104 where at least one of said plurality of strands is woven in a secondary direction; and a throat 106 where said braided rope 100 transitions from said main rope 100 body to said eye 104; wherein said throat 106 forms by said at least one of said plurality of strands woven in a second direction coupling to said main body.

### DETAILED DESCRIPTION OF DRAWINGS

FIG. 1a shows a sling 102 with an eye 104 at one end only.

FIG. 1b shows an alternative exemplary embodiment with an eye 104 at both ends.

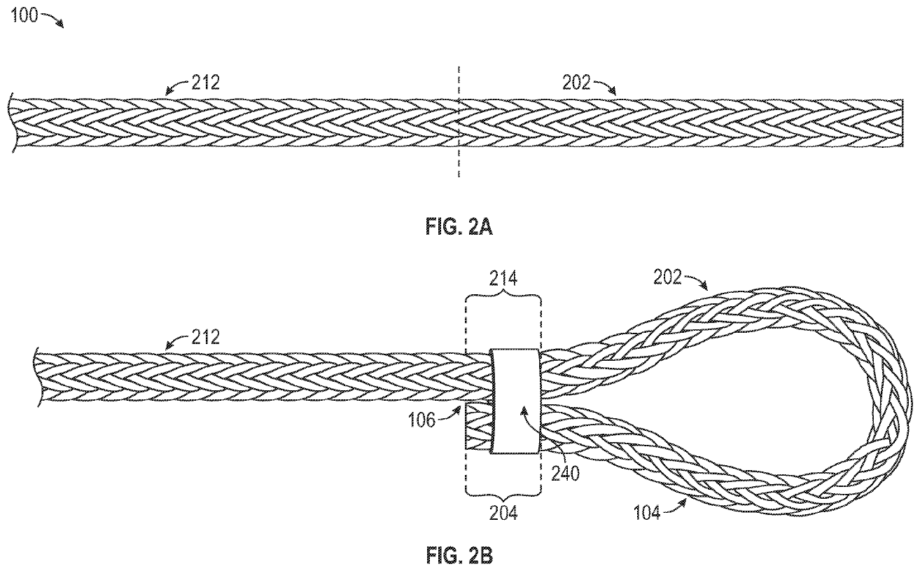

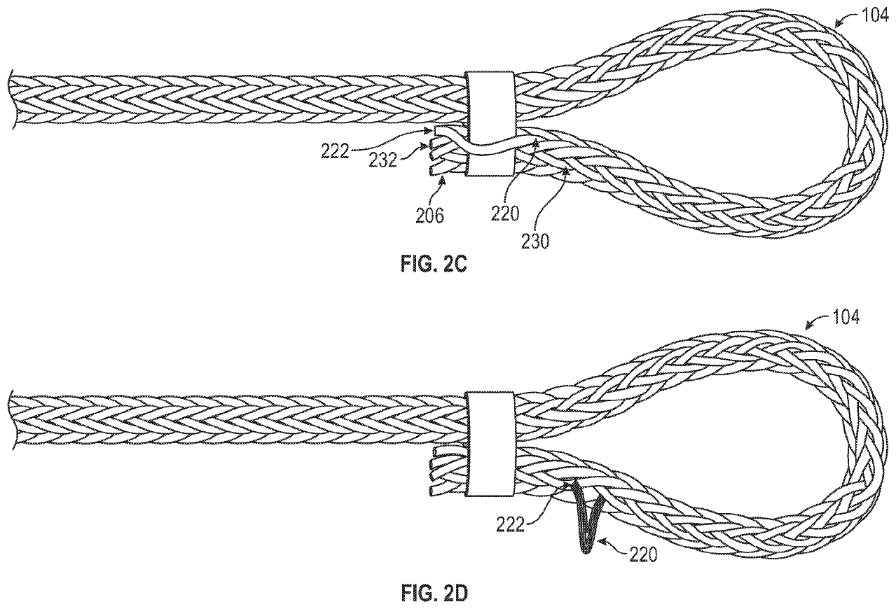

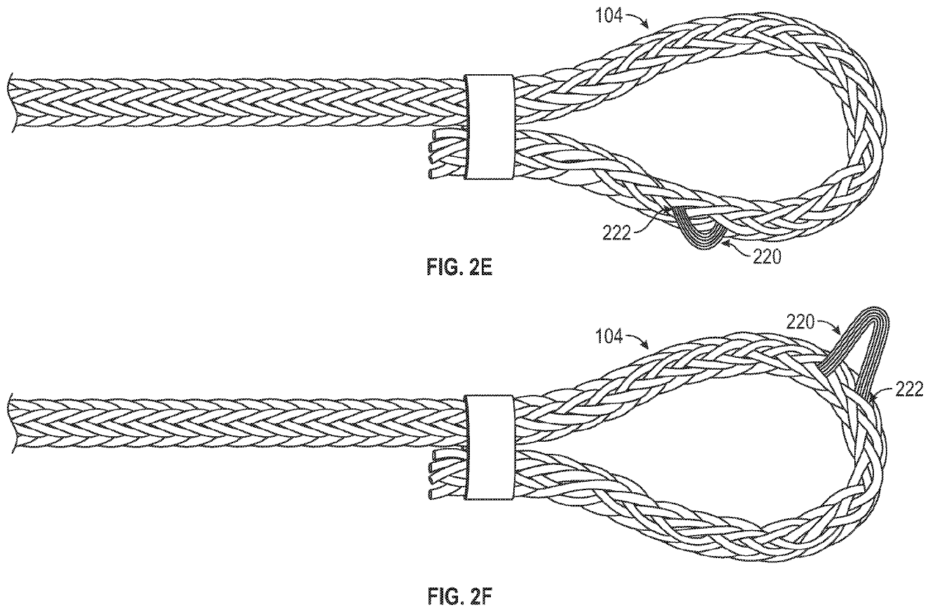

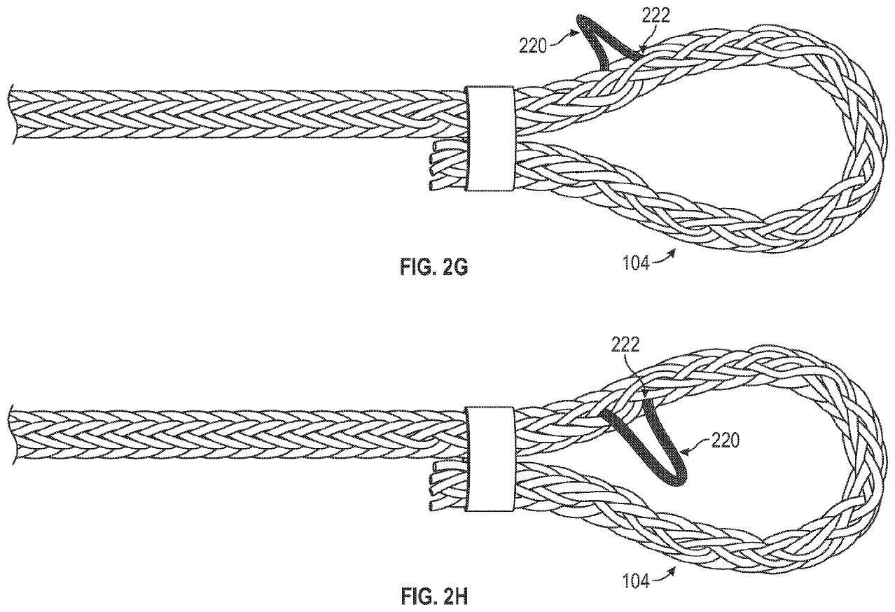

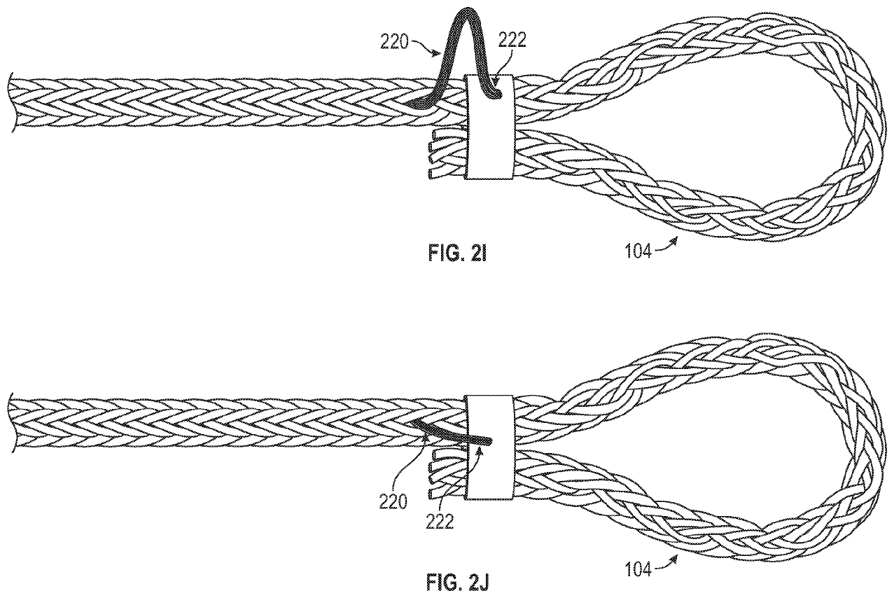

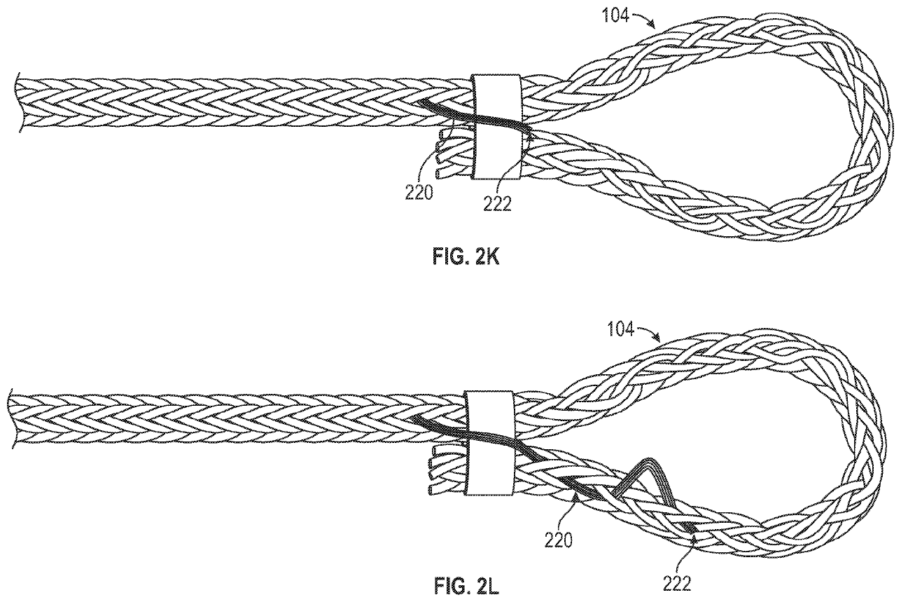

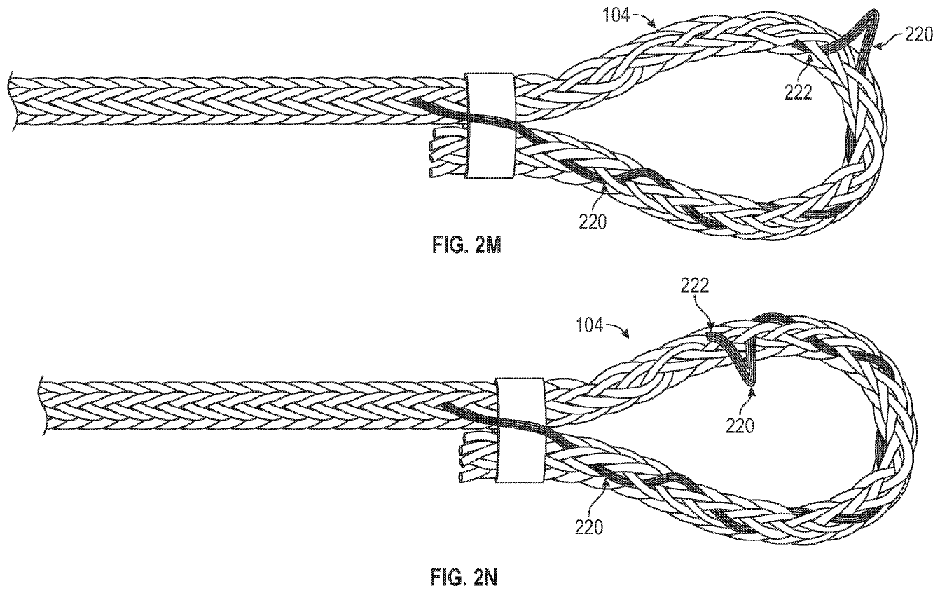

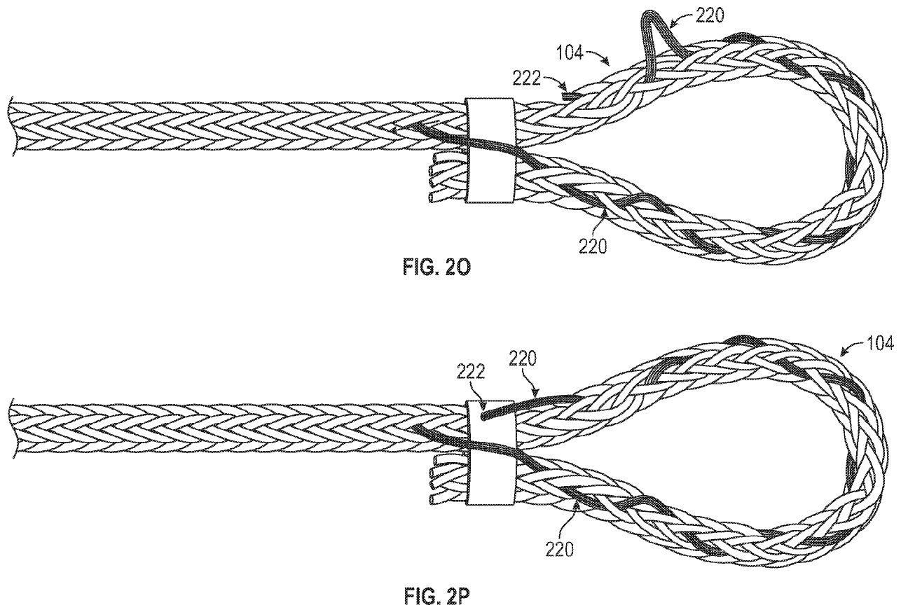

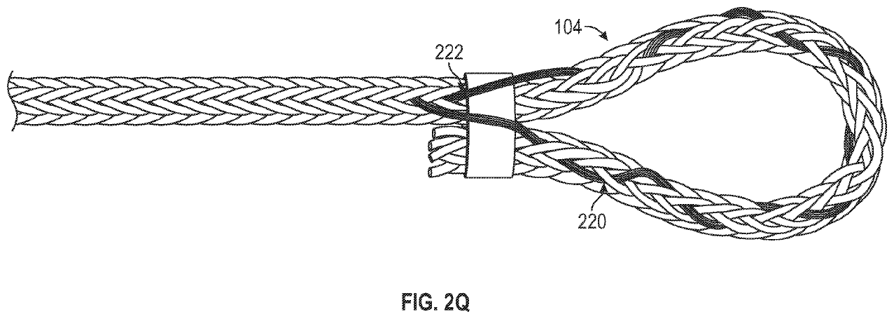

FIG. 2a shows a simplified rope 100 without an eye 104.

FIG. 2b shows the simplified rope 100 from FIG. 2a where it is oriented to form an eye 104.

FIG. 2c shows the simplified rope 100 from FIG. 2b where a distal end of a primary oriented strand 110 is loosened.

FIG. 2d-i shows the simplified rope 100 of FIG. 2c, showing the progress of withdrawing the primary oriented strand 220 through the eye 104 until the primary oriented strand is now loose in the central throat 106 area.

FIG. 2j shows the simplified rope 100 of FIG. 2i where the distal end of the primary oriented strand has been completely withdrawn from the eye 104.

FIG. 2k-p shows the simplified rope 100 of FIG. 2j, where primary oriented strand threaded back through the eye 104 starting at the distal throat section 204.

FIG. 2q shows the simplified rope 100 of FIG. 2p where the primary oriented strand 220 may now be tucked back in the rope 100.

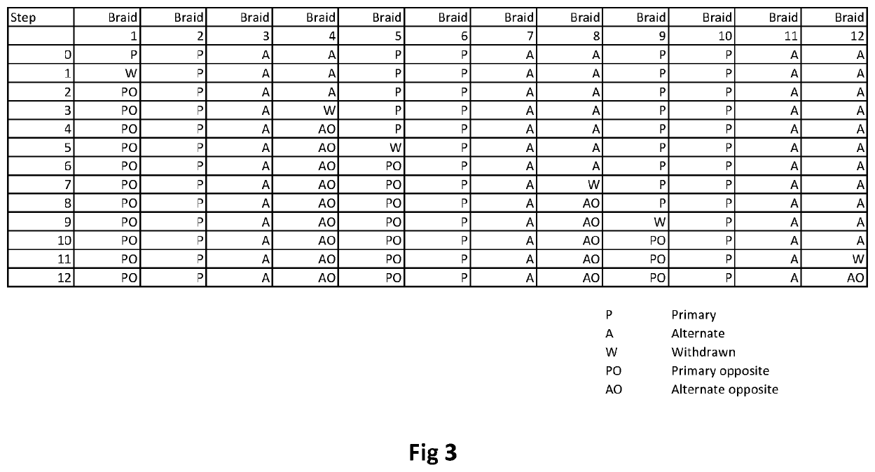

FIG. 3 is a chart showing the alteration of the strands 110 per an exemplary embodiment.

### DETAILED DESCRIPTION OF EXEMPLARY EMBODIMENTS

An exemplary embodiment of the disclosed invention involves a sling 102 made from a single length of rope 100 comprised of strands 110 (alternating between primary oriented strands 220 and alternative oriented strands 230) initially woven together in a first direction. The primary oriented strand distal ends 222 and the alternative oriented strand distal ends 232 are both located initially in the distal end 206 of the rope 100. The invention involves at least one of the primary oriented strands 220 and at least one of the alternative oriented strands 230 becoming woven back into the rope 100 such that one or more strands 110 now transition from a first direction to a second direction as the rope 100 becomes the resulting sling 102 with an eye 104. The primary oriented strands 220 and alternative oriented strands 230 that weave in a second direction couple back to the main rope 100 at the throat 106.

An exemplary embodiment of the disclosed invention utilizes a method of braiding rope 100 to create the eye 104 with a splice while minimizing the amount of rope 100 used. As shown in FIG. 2a, the distal section 202 of the rope 100 is the part where the eye 104 will form, as opposed to the central section 212 which makes up the remainder of the rope 100. FIG. 2b shows the area where the rope 100 comes back on itself is called the throat 106 and is made up of two sections: the distal throat section 204 and the central throat section 214. The distal throat section 204 will be defined as the section of the rope 100 between the eye 104 and the distal end 206 of the rope 100. The central throat section 214 will be defined as the section of the rope 100 between the eye 104 up to a line defined by the distal end 206 of the rope 100.

To make the sling 102, the first step is to calculate how large to make the eye 104. In an exemplary embodiment, the amount of rope 100 needed to form the eye 104 may be based on the diameter of the rope 100 used to maintain strength. In an exemplary embodiment, the length of rope 100 needed to form the eye 104 may be twenty four times the diameter of the rope 100 used. This factor will change based on peculiarities of the rope 100, and other factors may take any form while remaining in the scope of the invention. Once eye 104 size is determined, the amount of rope 100 needed for the eye 104 is calculated. In an exemplary embodiment, the amount of rope 100 needed is equal to the amount of rope 100 used for the eye 104 plus an additional 25% of that same length to secure it to the central throat section 214.

In an exemplary embodiment, the distal end 206 of the rope 100 is manipulated in a manner where the individual primary oriented strands 220 and alternative oriented strands 230 become loose and may be separated at the distal end 206 of a rope 100. The eye 104 is formed when at least one of the primary oriented strands 220 and at least one of the alternative oriented strands 230 are woven in a manner causing an eye 104 to form where at least at least one primary oriented strand 220 and at least on alternative oriented strand 230 is woven in a parallel but opposite direction from the original orientation of the strand 110. The result is an eye 104 where up to half of the strands 110 are woven in a parallel but opposed manner to result in an eye 104.

A simplification of an exemplary process of creating the sling 102 is shown in FIG. 2a-q. For purposes of illustration only, the rope 100 consists of primary oriented strands 220 and alternative oriented strands 230 in a helix configuration. A binder 240 is used to initially hold the distal end 206 of the rope 100 in place, but may not be needed to practice the invention.

At the distal end 206 of the rope 100, a primary oriented strand 220 is loosened as shown in FIG. 2c. The primary oriented strand 220 is then extracted through the rope 100 up to the central throat section 214 as shown in FIGS. 2d-2i. The withdrawal of the primary oriented strand 220 creates a void in the rope 100. The primary oriented strand distal end 222 then enters the throat 106 in the distal throat section 204 and goes back through the void created by the earlier withdrawal of primary oriented strand 220. The primary oriented strand 220 is now occupying substantially the same position as before, but oriented in the opposite direction. After the primary oriented strand 220 is threaded back through the eye 104, it is then tucked back into the central throat section 214 as shown in FIG. 2q.

While FIG. 2k shows the insertion of the primary oriented strand distal end 222 into the distal throat section 204 up from the binder 240, it is understood that the primary oriented strand distal end 222 may be inserted into the distal end 206 of the rope 100 and accomplish the same objective.

After the withdrawal of a primary oriented strand 220, an alternative oriented strand 230 may now be removed. The procedure is substantially similar to the procedure previously shown in FIG. 2a-q. At the distal end 206 of the rope 100, an alternative oriented strand 230 is loosened. The alternative oriented strand 230 is then extracted through the rope 100 up to the central throat section 214. The withdrawal of the alternative oriented strand 230 creates a void in the rope 100. The alternative oriented strand distal end 232 then enters the throat 106 in the void created by the earlier withdrawal of alternative oriented strand 230, but oriented in the opposite direction. After the alternative oriented strand 230 is threated back through the eye 104, it is then tucked back into the central throat section 214.

The process of withdrawing and rethreading primary oriented strands 220 and alternative oriented strands 230 is repeated. This may be repeated any number of times depending on the embodiment. In an exemplary embodiment, this is repeated until half of the primary oriented strands 220 and alternative oriented strands 230 have been modified.

In an exemplary embodiment, there are twelve strands 110 with six primary oriented strands 220 and six alternative oriented strands 230. FIG. 3 shows how the process may proceed with strands 110 in both a primary and alternative orientations. As shown in FIG. 3, primary oriented strands 220 are grouped in sets of two and are staggered with alternative oriented strands 230 in sets of two. As one strand 110 is withdrawn, and in the next strand 110 becomes oriented in the opposite orientation. This process is repeated until one strand of each set of two strands 110 are opposite of the their original counterpart.

Securing the primary oriented strands 220 and alternative oriented strands 230 may be coupled by any means know to those skilled in the art. One means may be by tucking the strands 110 back into the rope 100. Alternatively, they may be secured back to the rope 100 by binding to the primary oriented strand distal ends 222 with the alternative oriented strand distal ends 232 as opposed to using a traditional tuck. The process may be repeated with additional primary oriented strands 220 and additional alternative oriented strands 230.

For various reasons, it is preferred that when a strand 110 is guided back into the rope 100, it should fill the original location of the strands 110. However, when a strand 110 is withdrawn, it might be orientated in a manner that it cannot easily be reintroduced to its original location. A typical situation involves the strand 110 being blocked by the body of the rope 100 itself. In that situation, a fid is used to guide the distal end of the strand 110 through the body of the rope 100 to become adjacent to the point where it was reintroduced into the rope 100.

In the previously disclosed exemplary embodiments, the primary oriented strands 220 and alternative oriented strands 230 are threaded back through the rope 100 in their original locations. In an additional exemplary embodiment, the splicing of the eye 104 may be accomplished with the assistance of a guide. The guide is a filament that may be as long as the length of rope 100 used to form the eye 104. The dimensions of the guide allow the guide to occupy the void left by the withdrawal of a corresponding strand 110. Given the elasticity of the rope 100, the guide may be larger than the dimensions of the strand 110 removed. The guide has a first guide end and a second guide end. In an exemplary embodiment using a guide, the primary oriented strands 220 and an alternative oriented strands 230 are removed tuck by tuck. The guide is left behind in the rope 100 after the initial removal to assist in rethreading the primary oriented strand 220 and alternative oriented strands 230 back through the eye 104.

In an exemplary embodiment using a guide, the primary oriented strand 220 is loosed at the distal end 206. Before the primary oriented strand 220 is removed, the primary oriented strand distal end 222 is coupled to a first guide end. As the primary oriented strand 220 is withdrawn as shown in FIG. 2a-q, the guide is left in space created by the withdrawn primary oriented strand 220 and remains intertwined with the remaining rope 100. Once the primary oriented strand 220 is removed up to the central throat section 214, the first guide end is then decoupled from the primary oriented strand distal end 222. The guide remains in the eye 104 with the first guide end exiting at the central throat section 214 and the second guide end exiting at the distal throat section 204. The second guide end 254 is then coupled to the primary oriented strand distal end 222. The guide is withdrawn from the rope 100 from the first guide end through the central throat section 214. As the guide is withdrawn, the primary oriented strand 220 is rethreaded through the eye 104 and occupies the void left with the primary oriented strand 220 was initially withdrawn. The primary oriented strand 220 is then coupled back to the central throat section 214 as previously discussed.

The above disclosed process with the primary oriented strand 220 is repeated with the alternative oriented strand 230.

One of skill in the art will appreciate that the above disclosed embodiments provides a strong splice for eye formation while at the same time reducing the amount of rope 100 needed. Although specific embodiments are illustrated and described herein, it will be appreciated by those of ordinary skill in the art that any arrangement which is calculated to achieve the same purpose can be substituted for the specific embodiments shown. This specification is intended to cover any adaptations or variations of embodiments. In particular, one of skill in the art will appreciate that the names and terminology are not intended to limit embodiments. Furthermore, steps may be added or moved, additional apparatus can be added to the components, functions can be rearranged among components, and new components corresponding to future enhancements and future physical devices used in embodiments can be introduced without departing from the scope of the invention. The terminology used in this application is intended to include all embodiments and alternatives which provide the same functionality as described herein.

1. A sling with at least one eye, comprising:
a rope comprising a plurality of strands;
wherein said plurality of strands are separated at a distal end of said rope to form a split in said rope;
wherein said plurality of strands interweave in opposing directions back to said split;
wherein said plurality of strands form said eye when interwoven; and
wherein a throat forms where said plurality of strands merge back into said rope.

2. A rope with a plurality of strands partially oriented in alternating directions forming an eye, comprising the steps of:
determining a size for said eye;
identifying a throat location based on said size of said eye;
positioning a distal end of said rope adjacent to a central section of said rope;
creating a throat at said throat location, wherein said throat comprises:
a central throat section made from said central section of said rope; and
a distal throat section made from said distal section of said rope;
separating said plurality of strands at said distal end of said rope;
withdrawing a distal end of at least one primary oriented strand from said distal end of said rope to said central throat section;
inserting said distal end of said at least one primary oriented strand into said distal throat section;
interlacing said at least one primary oriented strand through said eye to said central throat section; and
securing said at least one distal end of said at least one primary oriented strand to said rope.

3. The rope from claim 2:
wherein withdrawing said distal end of said at least one primary oriented strand uses a guide with a first guide end and a second guide end, further comprising:
coupling said first guide end to said distal end of said at least one primary oriented strand before it is withdrawn;
interlacing said guide through said rope as said at least one primary oriented strand is withdrawn;
decoupling said first guide end from said distal end of said at least one primary oriented strand;
wherein inserting said distal end of said at least one primary oriented strand into said distal throat section further comprises coupling said second guide end to said distal end of said at least one primary oriented strand; and
wherein interlacing said at least one primary oriented strand through said distal throat section up to said central throat section is accomplished by withdrawing said first guide end from said central throat section, causing said distal end of said primary oriented strand to be interlaced through said eye.

4. The rope from claim 2, created further comprising the steps of:
withdrawing a distal end of at least one alternative oriented strand from said distal end of said rope to said central throat section;
inserting said distal end of said at least one alternative oriented strand into said distal throat section;
interlacing said at least one alterative oriented strand through said distal throat section up to said central throat section; and
securing said at least one distal end of said at least one alternative oriented strand into said rope.

5. The rope from claim 4, wherein securing said distal end of said primary oriented strand and securing said distal end of said at least one alternative oriented strand further comprises the step of binding said distal end of said primary oriented strand and said distal end of said alternative oriented strand together.

6. The rope from claim 3:
wherein withdrawing said distal end of at least one alternative oriented strand further comprises:
coupling a first guide end to said at least one distal end of said at least one alternative oriented strand before it is withdrawn;
interlacing said guide through said rope as said at least one alternative oriented strand is withdrawn;
decoupling said first guide end from said distal end of said at least one alternative oriented strand; and
wherein inserting said distal end of said at least one alternative oriented strand into said distal throat section further comprises coupling said second guide end to said distal end of said at least one alternative oriented strand; and
when interlacing said at least one alternative oriented strand through said distal throat section up to said central throat section is accomplished by withdrawing said first guide end from said central throat section, causing said distal end of said at least one alternative oriented strand to be interlaced through said eye.

7. The rope from claim 2, wherein identifying said throat location further compromises:
determining said size of said eye needed;
determining a length of rope needed to create said eye; and
determining a length of additional rope need to secure said distal section to said central section.

8. The rope from claim 7 wherein determining said additional length of rope to secure said distal section to said central section is determined by multiplying said length of rope needed to create said eye by a predetermined factor.

9. The rope from claim 8, wherein said predetermined factor is 25% of the length of rope needed to create said eye.

10. The rope from claim 7 wherein determining said length of rope to create said eye is determined by multiplying the diameter of said rope by a predetermined factor.

11. The rope from claim 10, wherein said predetermined factor is 24 times the diameter of the rope.

12. A method for splicing a rope, comprising:
withdrawing at least one primary oriented strand from said rope from a distal throat section of said rope through a central throat section of said rope;
reintroducing said at least one primary oriented strand into said distal throat section of said rope by:
inserting a distal end of said at least one primary oriented strand into said distal throat section; and
threading said at least one primary oriented strand from said distal throat section through said eye into said central throat section; and
securing said distal end of said at least one primary orientated strand into said central throat section.

13. The method of claim 12, wherein withdrawing said at least one primary oriented strand from said rope from said distal throat section of said rope through said central throat section of said rope further comprises:
attaching a first guide end of a guide to said distal end of said at least one primary oriented strand;
wherein withdrawing said at least one primary oriented strand from said rope from said distal throat section of said rope causes said guide to enter said rope and occupy the same position as said at least one primary oriented strand occupied before withdrawing said at least one primary oriented strand from said rope from said distal throat section of said rope.

14. The method of claim 13, wherein inserting said distal end of said at least one primary oriented strand into said distal throat section further comprises:
coupling a second guide end of said guide to said distal end of sad at least one primary oriented strand.

15. The method of claim 14, wherein threading said at least one primary oriented strand from said distal throat section through said eye into said central throat section further comprises:
removing said guide from said central throat section; and
pulling said distal end of said at least one primary oriented strand through said rope to said central throat section.

16. The method of claim 12, further comprising:
withdrawing at least one alternative oriented strand from said rope from said distal throat section of said rope through said central throat section of said rope;
reintroducing said at least one alternative oriented strand into said distal throat section of said rope by:
inserting a distal end of said at least one alternative oriented strand into said distal throat section; and
threading said at least one alternative oriented strand from said distal throat section through said eye into said central throat section; and
securing said distal end of said at least one alternative orientated strand into said central throat section.

17. The method of claim 16, wherein withdrawing said at least one alternative oriented strand from said rope from said distal throat section of said rope through said central throat section of said rope further comprises:
attaching a first guide end of a guide to said distal end of said at least one alternative oriented strand;
wherein withdrawing said at least one alternative oriented strand from said rope from said distal throat section of said rope causes said guide to enter said rope and occupy the same position as said at least one alternative oriented strand occupied before withdrawing said at least one alternative oriented strand from said rope from said distal throat section of said rope.

18. The method of claim 17, wherein inserting said distal end of said at least one alternative oriented strand into said distal throat section further comprises:
coupling said second guide end of said guide to said distal end of sad at least one alternative oriented strand.

19. The method of claim 18, wherein threading said at least one alternative oriented strand from said distal throat section through said eye into said central throat section further comprises:
removing said guide from said central throat section; and
pulling said distal end of said at least one alternative oriented strand through said rope to said central throat section.

20. The method of claim 12, wherein the pattern of threading said at least one primary oriented strand is substantially similar to the area vacated by the withdrawal of said at least one primary oriented strand from said rope.
